(19) United States
(12) Patent Application Publication
(10) Pub. No.: US 2009/0144822 A1
(43) Pub. Date: Jun. 4, 2009

(54) WITHHOLDING LAST PACKET OF UNDESIRABLE FILE TRANSFER

(75) Inventor: FLEMING SHI, CUPERTINO, CA (US)

Correspondence Address: PATENTRY, P.O. BOX 151616, SAN RAFAEL, CA, 94915-1616, US

(73) Assignee: BARRACUDA INC., CAMPBELL, CA (US)

(21) Appl. No.: 11/948,773

(22) Filed: Nov. 30, 2007

(51) Int. Cl. G06F 21/00

(52) U.S. Cl. 726/22

(57) ABSTRACT

A system and method for disrupting the download of undesirable files. A data store traps the final block or blocks of a file transfer which is held for detection of viruses, trojan horses, spyware, worms, dishonest ads, scripts, plugins, and other files considered computer contaminants. Innocuous file transfers are completed with minimum disruption as perceived by the user.

### BACKGROUND

A present threat to individuals, corporations, and governments is identity theft and misuse of computer resources attached to the Internet.

Computer contaminant within the present patent application means any set of computer instructions that are designed to modify, damage, destroy, record, or transmit information within a computer, computer system, or computer network without the intent or permission of the owner of the information. They include, but are not limited to, a group of computer instructions commonly called viruses or worms, which are self-replicating or self-propagating and are designed to contaminate other computer programs or computer data, consume computer resources, modify, destroy, record, or transmit data, or in some other fashion usurp the normal operation of the computer, computer system, or computer network.

Malware within the present patent application means software designed to infiltrate or damage a computer system without the owner's informed consent. It is a portmanteau of the words “malicious” and “software”. The expression is a general term used by computer professionals to mean a variety of forms of hostile, intrusive, or annoying software or program code.

Software is considered malware based on the perceived intent of the creator rather than any particular features. It includes computer viruses, worms, trojan horses, spy are, dishonest adware, and other malicious and unwanted software.

Undesirable software may be defined according to the security policy administrators of a network of computers. What is desirable software in a user's home computer may be defined by the user's school, place of employment, or public facility such as a library or internet cafe as undesirable. Specific browser plug-ins, active-x scripts, java scripts, macros, toolbars, add-ons, and applications may be defined to be undesirable in an ad hoc or formal policy. Certainly, computer contaminants commonly called viruses, and malware which records private user information such as passwords, are generally agreed to be undesirable in all cases.

A method of widely distributing computer contaminants and malware is bundling them with desirable software which a user downloads off the Web or a peer-to-peer file-trading network or receives on electronic media such as a flash drive, or portable disk storage. In some cases identity theft is enabled by a fraudulent email or website which tricks a user into clicking on a link which initiates a file download. In some cases this data stream is initiated without the users' conscious agreement by appearing to be a different function, url, or file type.

In most cases, files are what they present themselves to be but the consequences of being misled are great. Files are commonly streamed as a series of packets which are received and reassembled at the destination. Established network protocols determine if a packet is lost or corrupted, can request retransmission of select packets or can terminate a connection. Conventional network security operates by isolating a file outside of a protected network in a data store until it has been determined to be safe. This conventional solution unfortunately penalizes users by delaying the effective delivery of many desirable files and requiring large reserve storage resources to prevent overrunning capacity.

Thus it can be appreciated that what is needed is a way to protect users from downloading undesirable files without excessively delaying the download of desirable files or congesting the network with choke points. What is undesirable may be defined by owners or administrators of networks but generally includes computer contaminants such as viruses and malicious software such as password stealing store and forward agents.

### SUMMARY OF THE INVENTION

When a file is requested by a destination, all but (at least) one last block or packet is streamed to the destination but at least one of the last blocks or packets is withheld from the destination. A process examines all of the file for characteristics of undesirable content such as viruses and causes the withheld data to be either delivered to the destination or discarded if undesirable.

### BRIEF DESCRIPTION OF DRAWINGS

FIG. 1 is a schematic of a conventional firewall with storage as a gateway between a file source and a file destination.

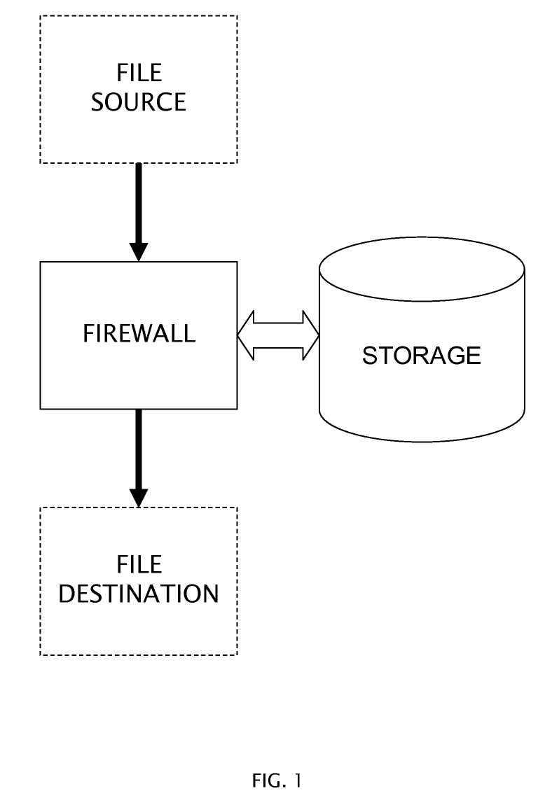

FIG. 2 is a schematic of the present invention coupled to a first network having a file source and coupled to a second network having a file destination.

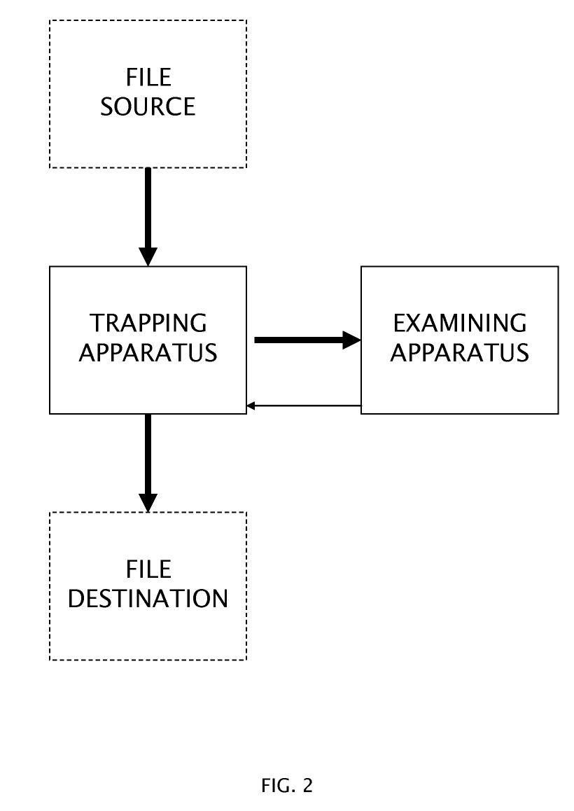

FIG. 3 is a flowchart of the method of the present invention.

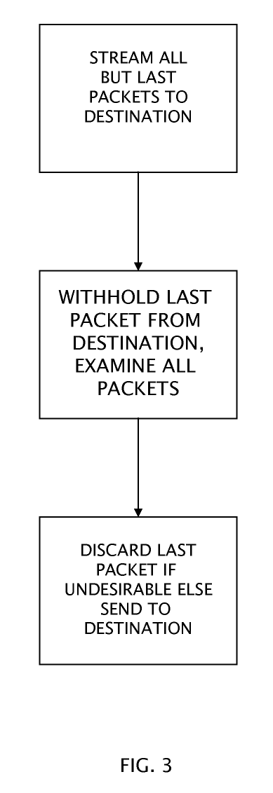

### DETAILED DESCRIPTION

In the present patent application, an undesirable file is defined to be a file which may or may not contain desirable content but has at least one of the following: a computer contaminant, malware, or software that is considered undesirable by the network owner or administrator by policy.

The present invention is a method for protecting users from downloading undesirable files such as malicious software or computer contaminants, comprising an examination process, and a trapping process wherein the trapping process streams all but at least one block of a file to a destination which has requested a file from a source and wherein the trapping process withholds at least one block of a file requested from the source by the destination. Blocks may include but are not limited to
at least one packet of a file transfer,
a certain plurality of bytes of a file transfer, or
the last packet or packets of a data communication network protocol.

The examining process receives all of the blocks of a file requested by a destination from a source, determines if the file contains an undesirable file such as a computer contaminant or malicious software and signals the trapping process to dispose of the data store contents. There are various methods known to those skilled in the art for detecting undesirable content such as but not limited to the following:
comparing a checksum with that of known computer contaminant in a database,
policy violation,
keyword pattern searching,
content analysis,
file type determination process, and
a virus scanning process.

The definition of computer contaminant includes but is not limited to computer viruses, worms, trojan horses, spyware, keystroke loggers, dishonest adware, and other malicious and unwanted software categorized as undesireable by network owners.

The method further comprising the step of disposing of the withheld data which includes but is not limited to the following:
transferring the data intact to the destination if no undesirable software is found,
signaling the destination to terminate the transfer,
signaling the destination to disregard the transfer,
not delivering the withheld data and refusing future connections to the source,
delivering more than the expected number of packets,
delivering at least one packet with a disabled payload,
delivering at least one packet with a changed checksum, or
transmitting a TCP/IP reset.

The method can be further extended to stopping all future transfers from the source of the computer contaminant. The method further comprises the step of transmitting warning messages to the requesting user, the system administrator or to both.

The present invention is a method comprising the steps of
receiving at least one packet corresponding to a file from a source,
transferring all but at least one of the last packets to a destination,
withholding at least one last packet of the file,
examining all the packets for a computer contaminant, and
discarding at least one of the last packets of the file transfer if the examination determines the file is undesirable.

The present invention further comprises the steps of
receiving at least one packet corresponding to a file from a source,
transferring all but at least one of the last packets to a destination,
withholding at least one of the last packets of the file,
examining all the packets for a computer contaminant, and
transferring the withheld packets of the file transfer to the destination if the examination determines the file is not undesirable.

The invention may be tangibly embodied as a system comprising a first examining apparatus coupled to a second trapping apparatus further coupled to a first network containing a file source, and further coupled to a second network containing a file destination, whereby all but at least one packet of a file from a source is transferred through to the destination, and at least one last packet is data stored and only transferred to the destination if the first examining apparatus determines that it is innocent.

In summary the present application discloses a system for preserving the user experience of seeing progress visually displayed for a file download immediately on request and receiving a file without an intermediate send/receive cycle comprising an apparatus and a method;
wherein the apparatus comprises a data store to withhold at least one block of data of a file requested from a source by a destination, and
wherein the method comprises the process of streaming all but at least one of the blocks of data of a requested file to the file destination,
examining all the blocks of the file for a computer contaminant and
discarding of at least one of the blocks of a requested file according to the examination for computer contaminant.

### Preferred Embodiment

Rather than erecting a wall, the present invention traps a virus or malicious file by withholding at least one block of data, in an embodiment, one or more packets, from the destination. The complete file is streamed to the examining process and to the destination simultaneously with the exception of a withheld packet or packets. The connection between source and destination can be reset or the last packet can be flagged with an error to prevent completion of the file transfer if the examining process signals a positive match with a known computer contaminant such as a virus or other malicious software.

An embodiment of the present invention is a method comprising the steps of
receiving at least one block (such as a packet) of a file from a source,
simultaneously transferring all but the last block of data to both a destination and to an apparatus for detecting a computer contaminant, wherein a block can be one or more packets or a number of bytes
withholding the last block of the file from the destination,
examining all the blocks for evidence of a computer contaminant, and
signaling the destination to ignore, terminate, or disregard at least one packet of the file transfer if the file is determined to contain undesirable content.

In an embodiment of the present invention, the method further comprises the steps of
receiving at least one block of data of a file transmitted from a source,
transferring all but the last block to a destination,
withholding the last block of the file,
examining any block for malicious content, and
transferring the last block of the file transfer to the destination if the examination finds no characteristic of an undesirable file wherein a block may be one or more packets or a number of bytes.

In an embodiment, the present invention is a system for preserving the user experience of seeing progress visually displayed for a file download immediately on request and receiving a non-malicious file without an intermediate send/receive cycle comprising an apparatus and a method. The apparatus comprises a first examining apparatus coupled to a second trapping apparatus, the second trapping apparatus further coupled to a first network containing a file source, and coupled to a second network containing a file destination. The method comprises the process of streaming all but at least one of the packets of a requested file to the file destination, streaming all of the packets of a requested file to the virus scanner, withholding at least one of the packets of a requested file in the file filter, and disposing of at least one of the packets of a requested file according to the findings of the virus scanner.

The meaning of disposing of at least one of the packets comprises transferring the withheld data packets to the destination if the file is found to be non-malicious, which completes the file transfer with minimum perception and disruption to the user.

On the other hand, if the file is malicious, there are many choices in disrupting the installation of the computer contaminant. We illustrate but do not limit the invention to the following:
simply not delivering the withheld packets,
delivering more than the number of expected packets,
delivering at least one packet with corrupted payload,
delivering at least one packet with corrupted TCP/IP checksum, and
transmitting a TCP/IP reset.

The method may further be enhanced by the step of automatically stopping all file transfers in future from the source of a file which the examining process determines is undesirable. This prevents any packets from that source in the first network streaming to any destination in the second network. The method can be further enhanced by displaying a warning message to the user and to the system administrator.
A tangible embodiment of the invention is a system comprising a first apparatus for detecting computer contaminant such as viruses coupled to a second apparatus for trapping a computer contaminant in a data store, which is further coupled to a first network containing a file source, and to a second network containing a file destination, whereby all but the last block or packet of a file from a source is transferred through to the destination, but the last packet is data stored at the trapping apparatus and held until the detecting apparatus determines that it is innocent.

### Conclusion

This invention has the advantage of minimizing the latency of downloading a file and providing virus protection with faster effective delivery. At the time the file is evaluated to be safe to download, only the last packet remains to be transferred. If the file is judged to be malicious, the destination has only received an incomplete and most likely inoperative virus which will be removed a part of system maintenance. It is an object of the present invention to disrupt the installation of the final packet or packets of a file transfer carrying computer contaminant on first attempt and to disrupt the installation of any packets from the same source on subsequent retries. It is an object of the present invention to protect users from malicious downloads without adding perceptible delay to downloading all other files. It is particularly effective when using checksums to detect known viruses.

The present invention is distinguished from conventional content vectoring protocols and IVP firewalls which data store and analyze an entire download prior to delivery to a destination. In conventional systems the first packet of a file is held back from the destination until the entire file has been analyzed and approved. The present method uses considerably less memory especially if the checksum in the last packet indexes into a database of viruses and malicious files. It is an objective of the present invention to address any user objection to using virus scanning due to delayed access to good files, to trap incoming viruses so that their file transfers are incomplete, and to prevent multiple retries.

The scope of the invention includes all modification, design variations, combinations, and equivalents that would be apparent to persons skilled in the art, and the preceding description of the invention and its preferred embodiments is not to be construed as exclusive of such.

What is claimed is:

1. A method comprising a computer contaminant detecting process, and a computer contaminant trapping process wherein the computer contaminant trapping process streams all but at least one block of a file to a destination which has requested a file from a source and wherein the computer contaminant trapping process withholds at least one block of a file requested from the source by the destination.

2. The method of claim 1 wherein a block is at least one packet of a file transfer.

3. The method of claim 1 wherein a block is a certain plurality of bytes of a file transfer.

4. The method of claim 1 wherein a file transfer comprises a data communication according to a network protocol selected from the following: CIFS, NFS, P2P, http, ftp, https, ftps, and TCP/IP.

5. The method of claim 1 wherein the computer contaminant detecting process receives all of the blocks of a file requested by a destination from a source, determines if the file contains computer contaminant and signals the computer contaminant trapping process to dispose of the data store contents.

6. The method of claim 5 wherein the computer contaminant detecting process comprises comparing a checksum with that of known computer contaminant in a database.

7. The method of claim 5 wherein the computer contaminant detecting process comprises a virus scanning process.

8. The method of claim 5 wherein computer contaminant comprises at least one of computer viruses, worms, trojan horses, spyware, keystroke loggers, dishonest adware, and other malicious and unwanted software categorized as a computer contaminant.

9. The method of claim 5 further comprising the step of disposing of the data store contents.

10. The method of claim 9 wherein disposing of the data store contents comprises transferring the data store intact to the destination if no computer contaminant is found.

11. The method of claim 9 wherein disposing of the data store contents comprises signaling the destination to terminate the transfer.

12. The method of claim 9 wherein disposing of the data store contents comprises signaling the destination to disregard the transfer.

13. The method of claim 9 wherein disposing of the data store contents comprises not delivering the data store and refusing future connections from the source.

14. The method of claim 9 wherein disposing of the data store contents comprises delivering more than the expected number of packets.

15. The method of claim 9 wherein disposing of the data store contents comprises delivering at least one packet with disabled payload.

16. The method of claim 9 wherein disposing of the data store contents comprises delivering at least one packet with changed checksum.

17. The method of claim 9 wherein disposing of the data store contents comprises transmitting a TCP/IP reset.

18. The method of claim 9 further comprising stopping all future transfers from the source of the computer contaminant.

19. The method of claim 9 further comprising transmitting a message to a user and to a system administrator warning of a potentially malicious file request.

20. A method comprising the steps of
receiving at least one packet corresponding to a file from a source,
transferring all but at least one of the last packets to a destination,
withholding at least one last packet of the file from the destination,
examining all the packets for a computer contaminant, and
disposing at least one of the last packets of the file transfer if a computer contaminant is found.

21. A method comprising the steps of
receiving at least one packet corresponding to a file from a source,
transferring all but at least one of the last packets to a destination,
withholding at least one of the last packets of the file,
examining all the packets for a characteristic of an undesirable file, and
transferring a withheld packet of the file transfer to the destination if the examination determines the file does not have a characteristic of an undesirable file.

22. A system comprising a first apparatus for detecting an undesirable file coupled to a second apparatus for trapping an undesirable file further coupled to a first network containing a file source, and further coupled to a second network containing a file destination, whereby all but at least one packet of a file from a source is transferred through to the destination, and at least one last packet is data stored at the second apparatus and only transferred to the destination if the first apparatus determines that the file is not an undesirable file.

23. A system for preserving the user experience of seeing progress visually displayed for a file download immediately on request and receiving a desirable file without an intermediate send/receive cycle comprising an apparatus and a method;
wherein the apparatus comprises a data store to capture at least one block of data of a file requested from a source by a destination, and
wherein the method comprises the process of
streaming all but at least one of the blocks of data of a requested file to the file destination, examining all the blocks of the file for a characteristic of an undesirable file and
disposing of at least one of the blocks of a requested file according to the examination for computer contaminant wherein disposing comprises delivering a block to a destination if the examination finds no undesirable file and discarding a block if the examination finds an undesirable file whereby the destination only receives an incomplete and inoperative fragment of a computer contaminant.
